(19) United States
(12) Patent Application Publication
(10) Pub. No.: US 2018/0050226 A1
(43) Pub. Date: Feb. 22, 2018

(54) Emergency Guidance Apparatus with Lighting

(71) Applicant: Jong Duck Park, Seoul (KR)

(72) Inventor: Jong Duck Park, Seoul (KR)

(21) Appl. No.: 15/672,694

(22) Filed: Aug. 9, 2017

(30) Foreign Application Priority Data
Aug. 17, 2016 (KR) 10-2016-0104347

(51) Int. Cl. A62B 3/00; G08B 7/06; G09F 19/12

(52) U.S. Cl. CPC A62B 3/00; G08B 7/062; G08B 5/36; G08B 7/066; G09F 19/12

(57) ABSTRACT

Disclosed is an emergency guidance apparatus which displays direction, situation informing letter and sign in a display unit, outputs a sound in a speaker, and turns on flickering light towards the right direction to evacuate so that the apparatus can guide evacuation and minimize the human casualties depending on the disaster type and situation. The emergency guidance apparatus with lighting according to an embodiment of the disclosure, which transmits to a central control unit the disaster signals detected by the disaster detection sensors that are installed in multiple places within building, and receives the processing signals transmitted by the central control part so as to guide the evacuation direction.

### CROSS-REFERENCE TO RELATED APPLICATION

This application is based on and claims priority from Korean Patent Application No. 10-2016-0104347 filed on Aug. 17, 2016 in the Korean Intellectual Property Office, the disclosure of which is incorporated herein in its entirety by reference.

### TECHNICAL FIELD

The present invention relates to an emergency guidance apparatus which guides a evacuation and minimizes human casualties when a disaster such as a fire, an earthquake, a collapse, an explosion, a gas leak, occurs in the public facilities like a building or a subway station.

### BACKGROUND OF THE INVENTION

The installation of emergency guidance apparatuses is mandatory in the public facilities such as a school, a hospital, a department store, a subway, etc. as a fallback against disasters like a fire or a explosion.

Such an emergency guidance apparatus is provided with the screen plate which is attached to the front plane of case and displays the direction of an emergency exit using an arrow, characters, figures, etc. and the lamp which is a light source and lights up on by electrical power. Also, the liquid crystal type of the emergency guidance apparatus is used recently, in which various images including an advertisement can be displayed.

In general, emergency guidance apparatuses are installed near the wall or entrance of a building. However, if a tire breaks out within the building, the inside of the building becomes full of smokes containing toxic gases. Thus, depending on the scale or situation of a fire, the emergency guidance apparatuses may not be readily identified by people escaping from the fire. The big accident of human casualties could happen in case that the recognition of emergency guidance apparatus is not secured.

Moreover, the guide sign of a general emergency guidance apparatus may not be recognized by the people escaping from the fire due to flames and smokes. In particular, the general emergency guidance apparatus has the problem of losing the guide function to the visually handicapped people escaping from a fire since it informs people of the location of emergency exit only by the light sign of a lamp.

Furthermore, the direction guided by the emergency guidance apparatus may be even dangerously wrong direction depending on the disaster situation. That is, a fire or a gas leak may occur in the exit direction. The conventional emergency guidance apparatus has such problem that the evacuators may be led to even more dangerous places because the conventional apparatus cannot react properly to the above mentioned situation.

### DOCUMENTS OF RELATED ART

1. Korean Patent Application Publication No. 10-2013-0073427 (2013 Jul. 3)

2. Korean Patent Registration No. 10-1317654 (2013 Oct. 7)

3. Korean Patent Application Publication No. 10-2006-0105214 (2006 Oct. 11)

### SUMMARY OF THE INVENTION

Accordingly, the present invention has been made to solve the aforementioned problems occurring in the related art, and it is an object of the present invention to provide the emergency guidance apparatus which can guide to the optimal evacuation places depending on the type of a disaster or a situation, and can deliver the visual and auditory information using letters, characters, sounds, lighting, etc. when a disaster such as a fire, an earthquake, a collapse, an explosion, a gas leak, etc. occurs in the public facilities like a building or a subway station.

### TECHNICAL SOLUTION

To achieve the above and other objects, in accordance with an embodiment of the present invention, there is provided an emergency guidance apparatus with lighting which receives a processing signal from a central control unit and guides an evacuation direction, the central control unit receives the disaster signals detected by the disaster detection sensors that are installed in multiple places within a building, comprising:

a main body which is installed in multiple places within building and provided with a signal processing unit therein that can communicate with the central control unit and a display unit in the front thereof with the electrical connection to the signal processing unit for displaying a direction guide, situation informing letters and characters depending on the types of the signals received to the signal processing unit;

a speaker which is provided at one side of the main body with electrical connection to the signal processing unit, and outputs a prescribed sound depending on the types of the signals received to the signal processing unit; and

a light which is provided adjacently to the main body in numbers with turning on or off function as well as with the electrical connection to the signal processing unit for communication, and irradiates a prescribed lighting towards the evacuation direction in association with the display unit depending on the types of the signals received to the signal processing unit.

### ADVANTAGEOUS EFFECT

According to the embodiment of the present invention having the above-described configuration, the emergency guidance apparatus has superior advantages such that a direction guide and the situation informing letters and characters are displayed, the sound is outputted from the speaker, and the light irradiates towards the right evacuation direction depending on the type and situation of disaster so that the human casualties can be minimized.

### BRIEF DESCRIPTION OF THE DRAWINGS

The above objects, other features and advantages of the present invention will become more apparent by describing the preferred embodiments thereof with reference to the accompanying drawings, in which:

FIG. 1 is the block diagram of the emergency guidance apparatus with lighting according to an embodiment of the present invention.

FIG. 2 is the installation diagram of the emergency guidance apparatus with lighting according to an embodiment of the present invention.

FIG. 3 shows the use case of the emergency guidance apparatus with lighting according to an embodiment of the present invention.

FIG. 4 is the installation diagram of the emergency guidance apparatus with lighting according to an embodiment of the present invention.

### *EXPLANATION OF REFERENCE NUMERALS FOR MAIN PARTS IN THE DRAWING

1, 1′; emergency guidance apparatus with lighting

10; main body

11; signal processing unit

12; display unit

20; speaker

30; light

40; disaster detecting sensor

50; central control unit

### DETAILED DESCRIPTION OF THE INVENTION

Although the present invention has been described with reference to the preferred embodiment in the attached figures, it is to he understood that various equivalent modifications and variations of the embodiments can be made by a person having an ordinary skill in the art without departing from the spirit and scope of the present invention as recited in the claims. The present invention is defined in the scope of claims and, throughout the description, like reference numerals designate like elements.

The description of the known function or configuration will be abbreviated if it is judged that such description may make the essence of the present invention obscure. The terminology used herein may be varied according to users, operator's intention, or practices. Accordingly, the terminology used herein is intended to be interpreted based on the overall description.

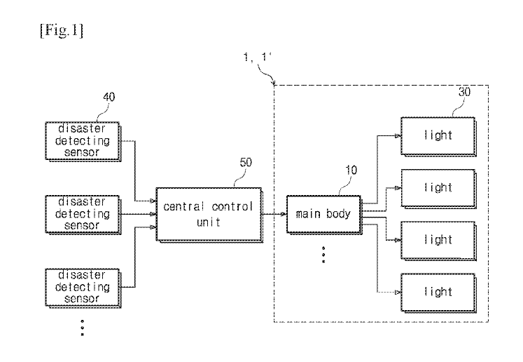

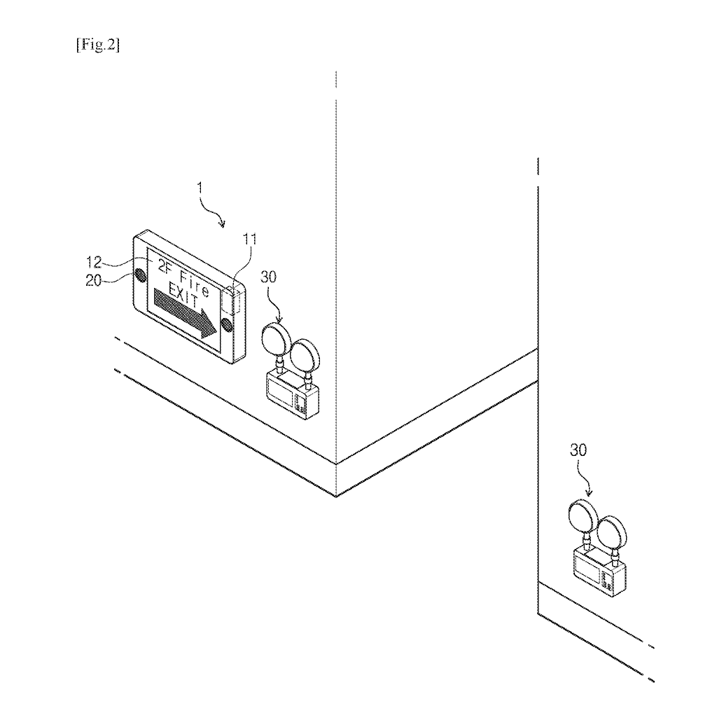

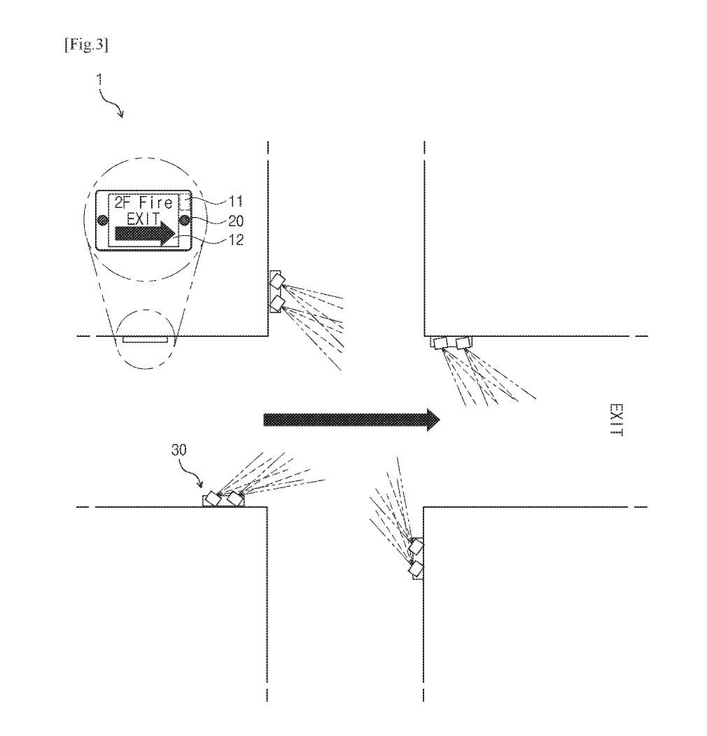

FIG. 1 to 4 illustrate one example according to the present invention. FIG. 1 is the block diagram and FIG. 2 is the installation diagram, and FIG. 3 shows the use case.

Hereinafter, the elements configuring the emergency guidance apparatus with lighting and the working relationship among them according to an example of the present invention will be described in detail.

Referring to FIG. 1 to 2, the emergency guidance apparatus (1) with lighting according to an embodiment of the present invention is used for guiding evacuation when the disasters such as fire, earthquake, collapse, explosion, gas leakage, etc. occur in the public facilities like a building or a subway station. When the disaster occurs, the type of disaster, location and scale of the disaster are detected by the disaster detecting sensors (40) installed in multiple places within building. The detected signal is transmitted to the central control unit (50) located in the building, and the central control unit (50) that receives the disaster signal transmits the processing signal to the emergency guidance apparatus. The emergency guidance apparatus that receives the processing signal guides the optimal place of evacuation using a display unit (12), a speaker (20), and a light (30), after considering all possible situations.

Referring to FIG. 2, the main bodies (10) are installed at the multiple places within the building. The main body (10) takes role of installation and connection of the elements described afterwards. Such main body (10) is preferably installed at the places such as major locations of the building, e.g. front of elevator, location near emergency exit stairway, etc.

The main body (10) is provided in the inside thereof with the signal processing part (11) to be possible to communicate with the central control part (50). And in the front thereof is provided with the display unit (12) which is electrically connected to the signal processing unit (11), and displays a direction guide, situation informing letters and characters depending on the types of the signals received to the signal processing unit (11).

The signal processing unit (11) described above receives the processing signal including the information on the disaster from the central control unit (50). For this, the signal processing unit (11) is connected to the central control unit (50) via wireline/wireless communication. Also, the display unit (12) is a digital signage for advertisement or a guiding light of emergency exit. The signal processing unit (11) displays selectively the letter information corresponding to the disaster and the direction arrow guiding the evacuation direction, depending on the type of the signals such as a tire signal, an earthquake signal, a collapse signal, an explosion signal, a gas leak signal, etc. For instance, if the signal is a fire signal, the later information like “000 fire” is displayed in the display unit (12), and at the same time, the evacuation direction is guided by the character like arrow.

On the other hand, the speaker (20) is provided at one side of the main body (10). The speaker (20) is electrically connected to the signal processing unit (11) and outputs the prescribed sound depending on the types of the signals received to the signal processing unit (11). That is, the speaker (20) outputs aloud the information of letters, characters, exit direction guiding evacuation, depending on the types of the signal such as a fire signal, an earthquake signal, a collapse signal, an explosion signal, a gas leak signal, etc. that are received to the signal processing unit (11). For example, if the signal is a fire signal, the alarm sound is outputted for a fixed time followed by the repeating guide like “Fire break out, Please evacuate promptly”. Accordingly, not only ordinary people but handicapped people, older man, and children who do not well recognize the situation relatively to the ordinary people can be evacuated quickly.

In addition, multiple lights (30) are installed with turning on or off function in the location adjacent to the main body (10). The light (30) guides the direction to be evacuated. The light (30) is connected to the signal processing unit (11) for communication, and irradiates the prescribed lighting towards the evacuation direction depending on the types of the signals received to the signal processing unit (11).

At this time, the lights (30) are installed in multiple places in the building with fixed or adjustable angle, and the different colors of light are illuminated depending on the types of the signals such as a fire signal, an earthquake signal, a collapse signal, an explosion signal, a gas leak signal, etc. that are received to the signal processing unit (11).

The light (30) is provided in every main body (10), and the fixed lights (30) should be installed at every turning point within the building. This is because only the light illuminating into the direction of evacuation among the turning points should be turned on. However, it would be fine to install the light (30) with adjustable angle at only one of turning points. This is because such light (30) can control the angle to the direction to evacuate among the turning points when the disaster occurs.

Also, the light (30) illuminates the specific colors depending on the type of the signals such as a fire signal, an earthquake signal, a collapse signal, an explosion signal, a gas leak signal, etc. For example, the blue color for a fire, yellow color for an earthquake, red color for a collapse, etc. can be illuminated. The color change is according to one of conventional technologies, and the lamp used is same as that used in search light according to the conventional technology.

Hereinafter, the overall method of using the emergency guidance apparatus with lighting will be described in detail with reference to FIG. 3 according to an embodiment of the present invention.

First, if a fire occurs in the specific place within the building, the fire is detected by the disaster detecting sensor (40). The disaster detecting sensor (40) detects the type, position, scale, etc. of the disaster, and the disaster signal is transmitted to the central control unit (50) in the building. The central control unit (50) that receives the disaster signal transmits the processing signal to the signal processing units (11) of the multiple main bodies (10). The signal processing unit (11) that receives the processing signal guides the optimal evacuation through the display unit (12), speaker (20) and light (30) in the main body (10) That is, the display unit (12) displays the situation alarming letters and the evacuation direction in response to the disaster. The speaker (20) outputs the warning sound with the information of disaster. Also, the light (30) is turned on towards the evacuation direction. Accordingly, the human casualties can be minimized since the optimal direction of evacuation can be guided as opposed to guiding the fixed direction.

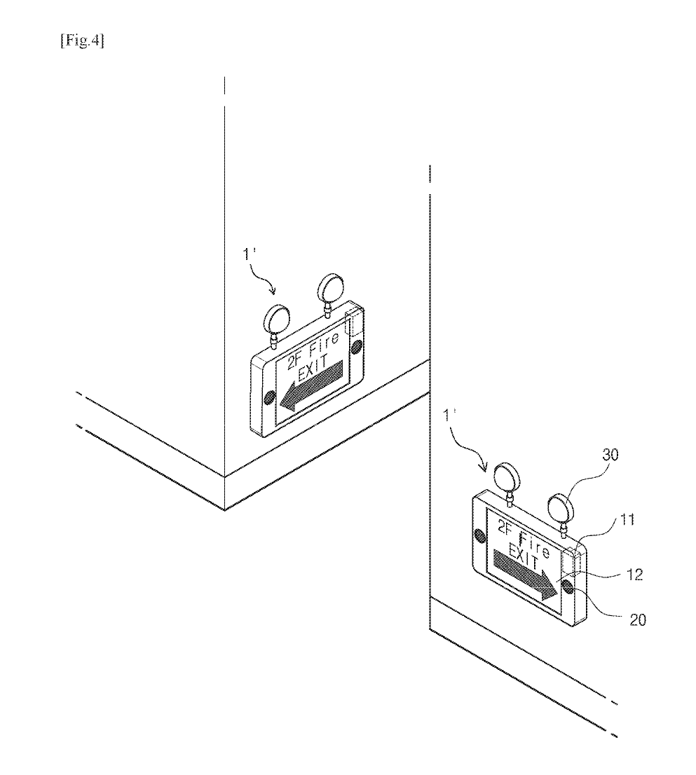

FIG. 4 is the installation diagram of the emergency guidance apparatus with lighting according to an embodiment of the present invention. The like reference numerals in FIG. 4 according to an embodiment of the emergency guidance apparatus with lighting (1) designate like elements.

The emergency guidance apparatus (1′) with lighting which An emergency guidance apparatus with lighting which receives a processing signal from a central control unit and guides an evacuation direction, the central control unit receives the disaster signals detected by the disaster detection sensors that are installed in multiple places within a building, comprising:

a main body which is installed in multiple places within building and provided with a signal processing unit therein that can communicate with the central control unit and a display unit in the front thereof with the electrical connection to the signal processing unit for displaying a direction guide, situation informing letters and characters depending on the types of the signals received to the signal processing unit;

a speaker which is provided at one side of the main body with electrical connection to the signal processing unit, and outputs a prescribed sound depending on the types of the signals received to the signal processing unit; and

a light which is provided at the other side of the main body with adjustable angle, with turning on or off function and with the electrical connection to the signal processing unit for communication, and irradiates a prescribed lighting towards the evacuation direction in association with the display unit depending on the types of the signals received to the signal processing unit.

The lights (30) are installed at the other side of the main body (10) with adjustable angle, and the different colors of light are illuminated depending on the type of the signals such as a fire signal, an earthquake signal, a collapse signal, an explosion signal, a gas leak signal, etc. that are received to the signal processing unit (11).

Since the emergency guidance apparatus (1′) with lighting according to another embodiment of the present invention is identical or similar to the emergency guidance apparatus with lighting according to an embodiment described above with respect to the configuration and working relationship, except for that the light (30) of the main body (10) is formed in one body, the descriptions that can be inferred from the aforementioned description will be abbreviated.

According to the emergency guidance apparatus (1) with lighting as described above, since a direction guide, situation informing letters and characters are displayed in the display unit (12), and the sound is outputted in the speaker (20) with the light (30) turned on towards the right direction of evacuation, the evacuation guide which minimizes the human casualties can be made depending on the disaster type and situation.

In the disclosure, since only exemplary embodiments have been described, those in the art may modify the described embodiments in various ways without departing from the scope of the claims which are not limited to the specific embodiment.

What is claimed is:

1. An emergency guidance apparatus with lighting which receives a processing signal from a central control unit and guides an evacuation direction, the central control unit receiving the disaster signals detected by the disaster detection sensors that are installed in multiple places within a building, comprising:
a main body which is installed in multiple places within building and provided with a signal processing unit therein that can communicate with the central control unit and a display unit in the front thereof with the electrical connection to the signal processing unit for displaying a direction guide, situation informing letters and characters depending on the types of the signals received to the signal processing unit;
a speaker which is provided at one side of the main body with electrical connection to the signal processing unit, and for outputting a prescribed sound depending on the types of the signals received to the signal processing unit; and
a light which is provided adjacently to the main body in numbers with turning on or off function as well as with the electrical connection to the signal processing unit for communication, and for irradiating a prescribed lighting towards the evacuation direction in association with the display unit depending on the types of the signals received to the signal processing unit.

2. The emergency guidance apparatus with lighting of claim 1, wherein
the display unit is a digital signage for advertisement or an emergency exit light, and displays selectively the letter information corresponding to the disaster and the direction arrow guiding an exit direction, depending on the types of the signals such as a fire signal, an earthquake signal, a collapse signal, an explosion signal, a gas leak signal that are received to the signal processing unit.

3. The emergency guidance apparatus with lighting of claim 1, wherein
the speaker outputs aloud the letter information corresponding to disaster and the evacuation guide information guiding an exit direction, depending on the types of the signals such as a fire signal, an earthquake signal, a collapse signal, an explosion signal, a gas leak signal that are received to the signal processing unit.

4. The emergency guidance apparatus with lighting of claim 1, wherein
the light is installed at the multiple places within building with fixed or adjustable angle, and illuminates different colors depending on the types of the signals such as a fire signal, an earthquake signal, a collapse signal, an explosion signal, a gas leak signal that are received to the signal processing unit.

5. An emergency guidance apparatus with lighting which receives a processing signal from a central control unit and guides an evacuation direction, the central control unit receiving the disaster signals detected by the disaster detection sensors that are installed in multiple places within a building, comprising:
a main body which is installed in multiple places within building and provided with a signal processing unit therein that can communicate with the central control unit and a display unit in the front thereof with the electrical connection to the signal processing unit for displaying a direction guide, situation informing letters and characters depending on the types of the signals received to the signal processing unit;
a speaker which is provided at one side of the main body with electrical connection to the signal processing unit, and for outputting a prescribed sound depending on the types of the signals received to the signal processing unit; and
a light which is provided at the other side of the main body with adjustable angle, with turning on or off function and with the electrical connection to the signal processing unit for communication, and irradiates a prescribed lighting towards the evacuation direction in association with the display unit depending on the types of the signals received to the signal processing unit.

6. The emergency guidance apparatus with lighting of claim 5, wherein
the display unit is a digital signage for advertisement or an emergency exit light, and displays selectively the letter information corresponding to the disaster and the direction arrow guiding the evacuation direction, depending on the types of the signals such as a fire signal, an earthquake signal, a collapse signal, an explosion signal, a gas leak signal that are received to the signal processing unit.

7. The emergency guidance apparatus with lighting of claim 5, wherein
the speaker outputs aloud the letter information of corresponding disaster and the evacuation guide information guiding an exit direction, depending on the types of the signals such as a tire signal, an earthquake signal, a collapse signal, an explosion signal, a gas leakage signal that are-received to the signal processing unit.

8. The emergency guidance apparatus with lighting of claim 5, wherein
the light is installed at the other side of the main body with adjustable angle, and illuminates different colors depending on the types of the signals such as a fire signal, an earthquake signal, a collapse signal, an explosion signal, a gas leak signal that are received to the signal processing unit.
